(19) United States
(12) Patent Application Publication
(10) Pub. No.: US 2002/0116321 A1
(43) Pub. Date: Aug. 22, 2002

(54) Systems and methods for optimizing use of mortgage insurance based upon projections of future home equity

(76) Inventor: Kurt L. Arehart, Raleigh, NC (US)

Correspondence Address: Peter H. Priest, Law Offices of Peter H. Priest, 529 Dogwood Drive, Chapel Hill, NC, 27516, US

(21) Appl. No.: 09/748,934

(22) Filed: Dec. 27, 2000

(51) Int. Cl. G06F 17/60

(52) U.S. Cl. 705/38

(57) ABSTRACT

Systems and techniques are described that allow prospective home buyers to see how much additional equity can be built up through the use of mortgage insurance. One described system includes a central processing unit having electronic access to mortgage insurance information stored in memory, and a user interface for receiving user inputs indicative of a borrower's financial situation, closing costs, loan terms, and a house value appreciation assumption. The central processing unit performs an analysis of the inputted information and calculates a maximum dollar amount of the purchase price of a house that the borrower can afford, based upon an optimal loan-to-value ratio, achievable using mortgage insurance, that maximizes future home equity. The central processing unit further calculates a maximum dollar amount of the purchase price of a house that the borrower can afford without using mortgage insurance. The central processing unit then provides results of the calculations to the user interface for output to the user.

### BACKGROUND OF THE INVENTION

1. Field of the Invention

The present invention relates generally to improvements to systems and methods for providing information to mortgage borrowers, and more particularly to advantageous aspects of systems and methods for optimizing the use of mortgage insurance based upon projections of future home equity.

2. Description of the Prior Art Mortgage insurance is an insurance policy that protects a lender against a default by a home buyer on a mortgage. With mortgage insurance, it is now possible for a home buyer to purchase a home with significantly less than the 20%, or greater, down payment that was formerly typically required. Thus, the availability of mortgage insurance provides today's home buyers with great flexibility in choosing a property. However, despite its potential benefits, mortgage insurance products are often not well understood by prospective home buyers and can therefore be difficult to sell.

There is thus a need for a system for analyzing the benefits of mortgage insurance to assist home buyers in using mortgage insurance in an optimal way.

### SUMMARY OF THE INVENTION

One aspect of the present invention provides systems and methods that allow prospective home buyers to see how much additional equity can be built up through the use of mortgage insurance. A first embodiment of the invention provides a system for optimizing the use of mortgage insurance based upon projections of future home equity. The system comprises a central processing unit having electronic access to mortgage insurance information stored in memory, and a user interface for receiving user inputs indicative of a borrower's financial situation, closing costs, loan terms, and a house value appreciation assumption. The central processing unit performs an analysis of the inputted information and calculates a maximum dollar amount for the purchase price of a house that the borrower can afford, based upon an optimal loan-to-value ratio, achievable using mortgage insurance, that maximizes future home equity. The central processing unit further calculates a maximum dollar amount of the purchase price of a house that the borrower can afford without using mortgage insurance. The central processing unit then provides results of the calculations to the user interface for output to the user.

Additional features and advantages of the present invention will become apparent by reference to the following detailed description and accompanying drawings.

### BRIEF DESCRIPTION OF THE DRAWINGS

FIG. 1 shows a diagram of a first embodiment of a system according to an aspect of the present invention.

FIG. 2 shows a table setting forth a traditional approach for calculating home affordability.

FIG. 3 shows tables and a graph illustrating an approach for calculating home affordability and projected future home equity according to a further aspect of the present invention.

FIG. 4 shows a diagram of a software architecture for implementing a system according to the present invention.

FIG. 5 shows a flowchart of a method according to a further aspect of the present invention.

### DETAILED DESCRIPTION

Mortgage insurance may be advantageously used to allow a home buyer to purchase a home with a smaller down payment than would otherwise be the case. Thus, mortgage insurance can be used to increase a home buyer's “leverage,” allowing a home buyer to buy a more expensive property with a smaller percentage of initial equity. It is assumed that real estate prices rise over time as a percentage of the initial purchase price. Thus, if a home buyer uses mortgage insurance to purchase a more expensive property, then over the course of several years the home buyer may have a greater dollar amount of home equity than would have been the case if the home buyer had not used mortgage insurance and instead had initially purchased a less expensive property with the same initial down payment.

However, the determination of how best to use mortgage insurance to maximize the home buyer's equity position over a given period of years is beyond the ability of a typical home buyer. A typical home buyer has limited funds for the down payment and closing costs. In addition, the buyer's income limits the amount of money that is available each month for the payment of principal, interest, taxes, and insurance (PITI). If a home buyer attempts to purchase a more expensive property, the home buyer must take into account increased closing costs, as well as increased PITI.

A first aspect of the present invention provides a system, herein referred to as the “Homeowner Equity Calculator” or simply as the “Calculator” that allows prospective home buyers to see how much additional home equity can be built up through the use of mortgage insurance. The Homeowner Equity Calculator serves both to allow the home buyer to make an informed decision concerning mortgage insurance and also provides a useful marketing tool for a seller of mortgage insurance.

Some existing calculators allow prospective home buyers to estimate how much house they can afford based upon their monthly income, but the Homeowner Equity Calculator goes well beyond this. The Homeowner Equity Calculator looks at each home buyer's income and cash status, selects the loan-to-value (“LTV”) ratio that maximizes affordability, and then demonstrates the superior equity growth that will result.

Working from a simple set of inputs including monthly income and available cash to close, the Homeowner Equity Calculator solves for the maximum amount of house affordable at traditional down payment levels. The Homeowner Equity Calculator then selects that down payment level which maximizes affordability, and projects homeowner equity based upon a home value appreciation assumption. In most cases, the use of mortgage insurance, which allows a small down payment, enables the home buyer to buy more house, and build more equity over time.

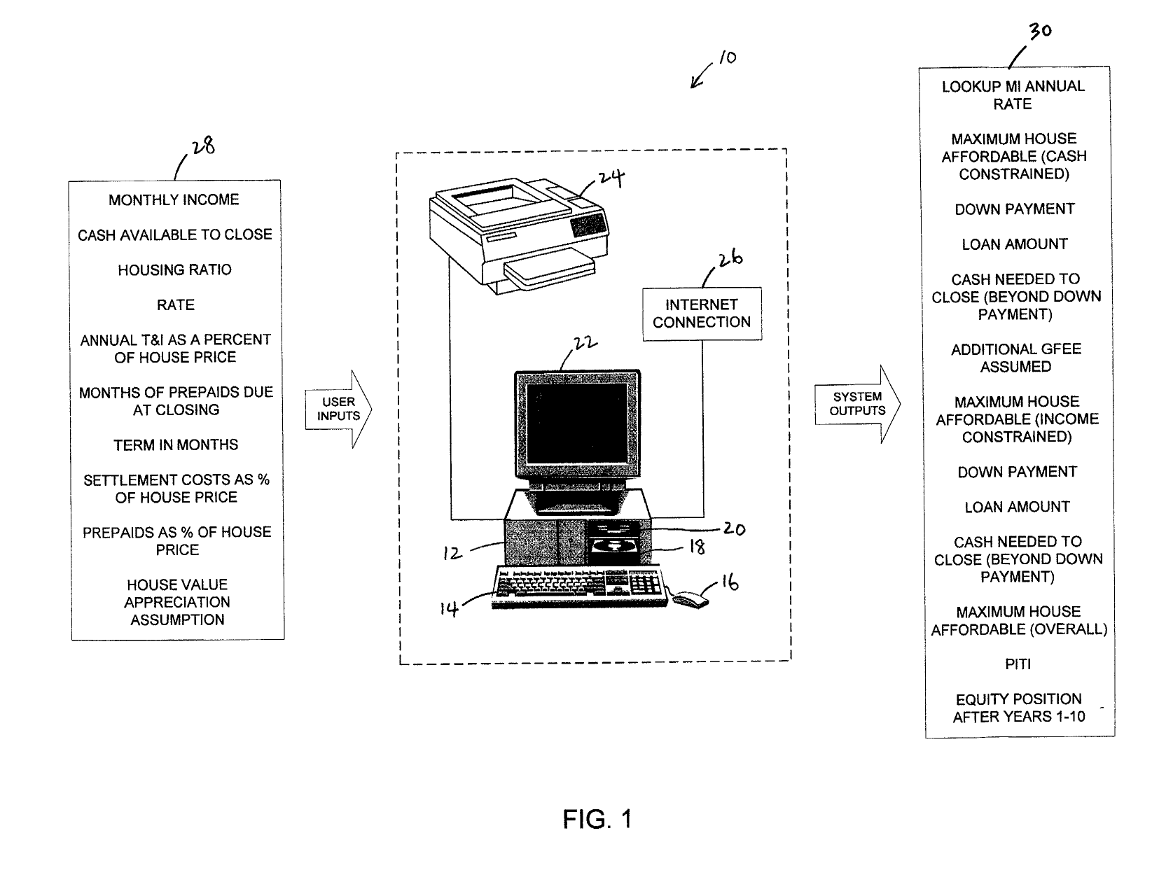

FIG. 1 shows a first embodiment of a system 10 according to a first aspect of the present invention. In this embodiment, the Homeowner Equity Calculator is run on a personal computer 12, workstation or other suitable stand-alone computing device. The computer 12 includes suitable input and output devices. In the FIG. 1 embodiment, these devices include: a keyboard 14, a mouse 16, a CD-ROM drive 18, a floppy diskette drive 20, and a monitor 22. The system 10 further includes a printer 24 and an Internet connection 26.

As described in further detail below, the user of the system 10 provides a number of inputs 28 and then receives a number of outputs 30. As shown in FIG. 1, the inputs to the system 10 include a number of pieces of information to be used in the home equity calculation. Each of these inputs and outputs are described below, in turn. As described further below, the outputs set forth below are calculated for various loan-to-value (LTV) scenarios to provide the buyer with alternatives.

Inputs

Monthly Income: The dollar amount of the home buyer's monthly pre-tax income.

Cash Available to Close: The dollar amount of funds available to the buyer to pay over at closing. This includes both the down payment and closing costs.

Housing Ratio: The percentage of the buyer's monthly income that is allocated for housing expenses.

Rate: The current mortgage rate.

Annual T&I as a Percent of House Price: The property tax and hazard insurance payments that will be due, expressed as a percentage of the house's purchase price.

Months of Prepaids Due at Closing: Number of months of prepaid expenditures due at closing.

Term in Months: The loan term, expressed as a number of months.

Settlement Costs as % of House Price: Settlement costs due at closing, expressed as a percentage of house price.

Prepaids as % of House Price: Prepaid amounts due at closing, expressed as a percentage of house price.

House Value Appreciation Assumption: Assumption as to appreciation of the value of the house over time, expressed as an annual percentage.

Outputs

Lookup MI Annual Rate: The amount of premiums due for mortgage insurance, expressed as an annual percentage. As described below, this amount is looked up by the system 10.

Maximum House Affordable (Cash Constrained): The maximum amount that the buyer can pay for a house, based upon the amount of cash available to close.

Down Payment: The amount of down payment required to purchase the maximum house affordable, constrained by the cash available to close.

Loan Amount: The amount of financing required to purchase the maximum house affordable, constrained by the cash available to close.

Cash Needed to Close (beyond Down Payment): The amount of cash beyond the down payment that is required to be paid by the buyer at closing.

Additional Gfee Assumed: The amount of an additional guarantee fee assumed where there is a zero down payment, expressed as a percentage of the loan amount.

Maximum House Affordable (Income Constrained): The maximum amount that the buyer can pay for a house, based upon the buyer's monthly income.

Down Payment: The amount of down payment required to purchase the maximum house affordable, limited by the buyer's monthly income.

Loan Amount: The amount of financing required to purchase the maximum house affordable, limited by the buyer's monthly income.

Cash Needed to Close (beyond Down Payment): The amount of cash required, beyond the down payment, to be paid by the buyer at closing.

Maximum House Affordable (Overall): The maximum amount that the buyer can pay for a house, based upon the lesser of the Maximum House Affordable (Cash Constrained) and the Maximum House Affordable (Income Constrained).

PITI: The combined dollar amount of principal, interest, property tax, and hazard insurance.

Equity Position after Years 1-10: The amount of home equity that will have been cumulatively built for each of the first ten years after the purchase.

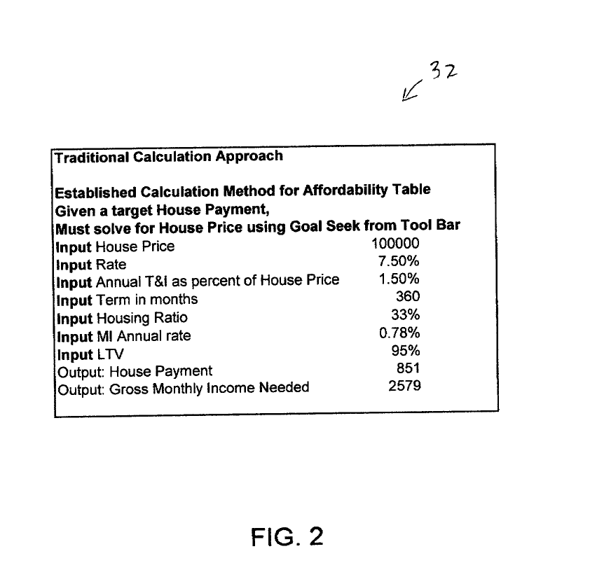

For the sake of comparison, FIG. 2 shows a table 32 listing inputs and outputs used in a traditional calculation approach. As shown in FIG. 2, the traditional approach typically uses only the inputs of house price, interest rate, annual tax and interest as a percentage of house price, the loan term in months, the housing ratio, the mortgage insurance annual rate, and the loan-to-value ratio. The outputs are the amount of the monthly house payment, and the amount of gross monthly income needed to support the monthly house payment. It will be appreciated that the calculations performed under the traditional approach do not provide a home buyer with the ability to make an informed decision concerning the optimal use of mortgage insurance.

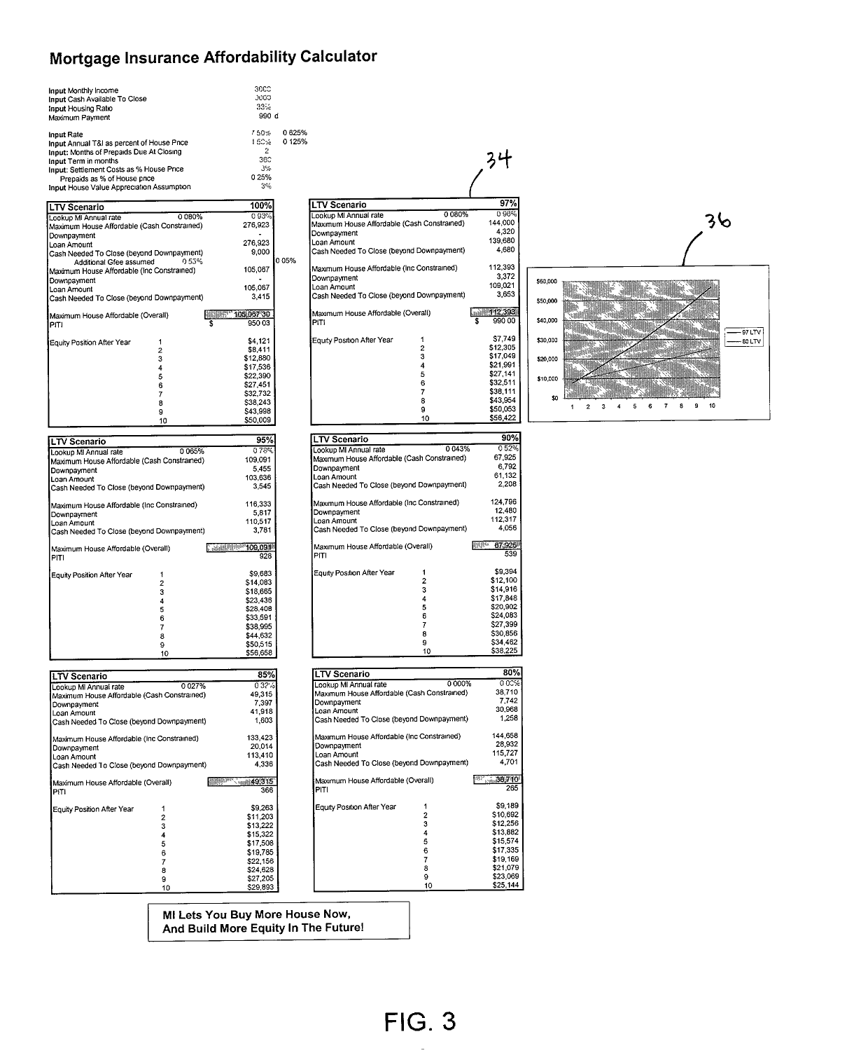

FIG. 3 shows the inputs and outputs in a system according to the present invention, with actual numbers inserted for the purposes of illustration. The outputs are shown as a series of tables 34, providing analyses for varying LTV ratios, ranging from 100% down to 80%. Within each table 34, the system lists the borrower's cumulative projected future home equity position for years one through ten. Assuming that the borrower's initial assumption concerning the appreciation of real estate values over time proves to be correct, and assuming that the borrower holds onto the property for the requisite number of years, it is generally to the borrower's advantage, from the point of view of maximizing future home equity, to purchase as expensive a property as the borrower can initially afford. The analyses contained in the tables 34 in FIG. 3 assist a borrower in determining an optimum LTV ratio, that is, an LTV ratio that maximizes projected future home equity. Once this optimum LTV ratio is determined, the Calculator generates a graphical representation 36 comparing the buildup of projected future home equity at the optimum LTV ratio (97% in this example) with the projected future home equity at the LTV ratio that is required by the lender if mortgage insurance is not purchased (typically 80%). As described further below, the borrower may freely explore alternative assumptions and scenarios by changing the inputs upon which the analyses are based.

The following equation is used to calculate the Maximum House Affordable (Income Constrained):

$$\frac{d ( \frac{( 1 - {( 1 + i )}^{- n} )}{i} )}{c + b ( \frac{( 1 - {( 1 + i )}^{- n} )}{i} ) + a c ( \frac{( 1 - {( 1 + i )}^{- n} )}{i} )}$$

In this equation, the following symbols are used:

a=MI premium rate÷12

b=T&I÷12

c=LTV

d=PMT (principal+interest only)

i=interest rate÷12

n=term in months

The following equation is used to calculate the amount of home equity that will be built up in the future:

$${P ( 1 + a )}^{y} - [ {L ( 1 + i )}^{12 y} - PMT ( \frac{{( 1 + i )}^{12 y} - 1 )}{( 1 + i ) - 1} ) ]$$

In this equation, the following symbols are used:

a=appreciation %

i=interest rate

n=loan term, in months

y=number of years projected

P=present value of the house

L=original loan amount

PMT=monthly payment (principal and interest only)

PMT is calculated using the following formula:

$$\frac{- L}{( \frac{( 1 - {( 1 + i )}^{- n} )}{i} )}$$

Similarly, the other outputs of the Calculator are calculated algebraically based upon the relationships of the various inputs and information stored in memory. For example, the Maximum Home Affordable (Cash Constrained) can be calculated using simultaneous equations. The sum of the down payment and the closing costs must be equal to the cash presently available to the borrower. Both the amount of the down payment and the amount of the closing costs are functions of the purchase price. Thus, for each selected LTV ratio, it is possible to solve for the Maximum Home Affordable (Cash Constrained) by taking all of these algebraic relationships into account.

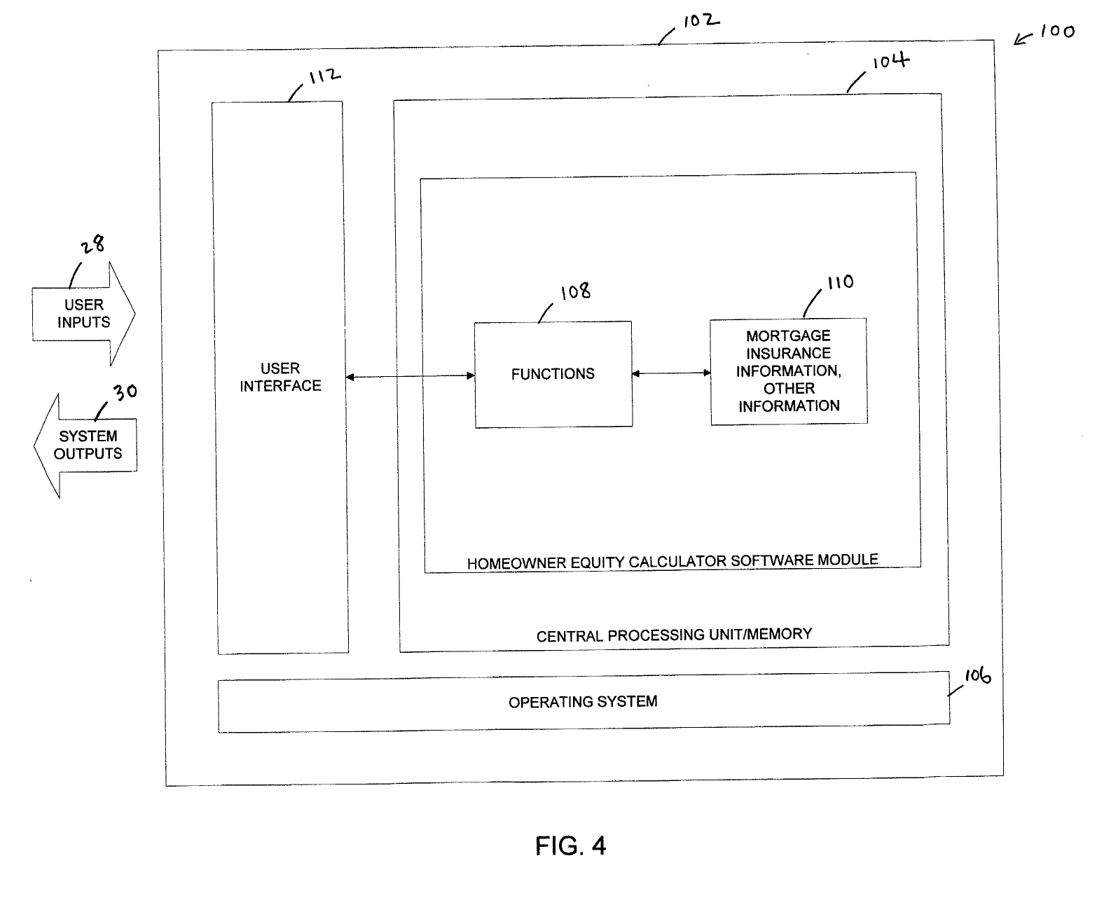

FIG. 4 shows a diagram of a software architecture 100 that can be used to implement the present invention. As mentioned above, it is contemplated that the system will be run on a stand-alone personal computer 102, workstation or other suitable computing device. Of course, however, the invention can be modified to be run in a network environment, or over the Internet.

The homeowner equity calculator software module 104 operates in conjunction with the computer operating system 106, which may, for example, be Microsoft Windows. One way to implement the system would be to use a spreadsheet program, such as Microsoft Excel. As shown in FIG. 4, the Homeowner Equity Calculator software module 104 includes a number of programmed functions 108, and also includes other information 110 needed to perform the calculations. The other information includes, for example, mortgage insurance rates. Some or all of the components of the software module 104 can be downloaded over the Internet from a remote website. Alternatively, the software module 104 can be loaded onto the computer 102 using a CD-ROM or floppy diskette. The system further includes a suitable user interface 112 for receiving inputs 28 from the user and, after the calculations have been performed, providing outputs 30 to the user. In a further embodiment of the invention, the software module 104 is capable of generating graphical analyses of the results of the analyses.

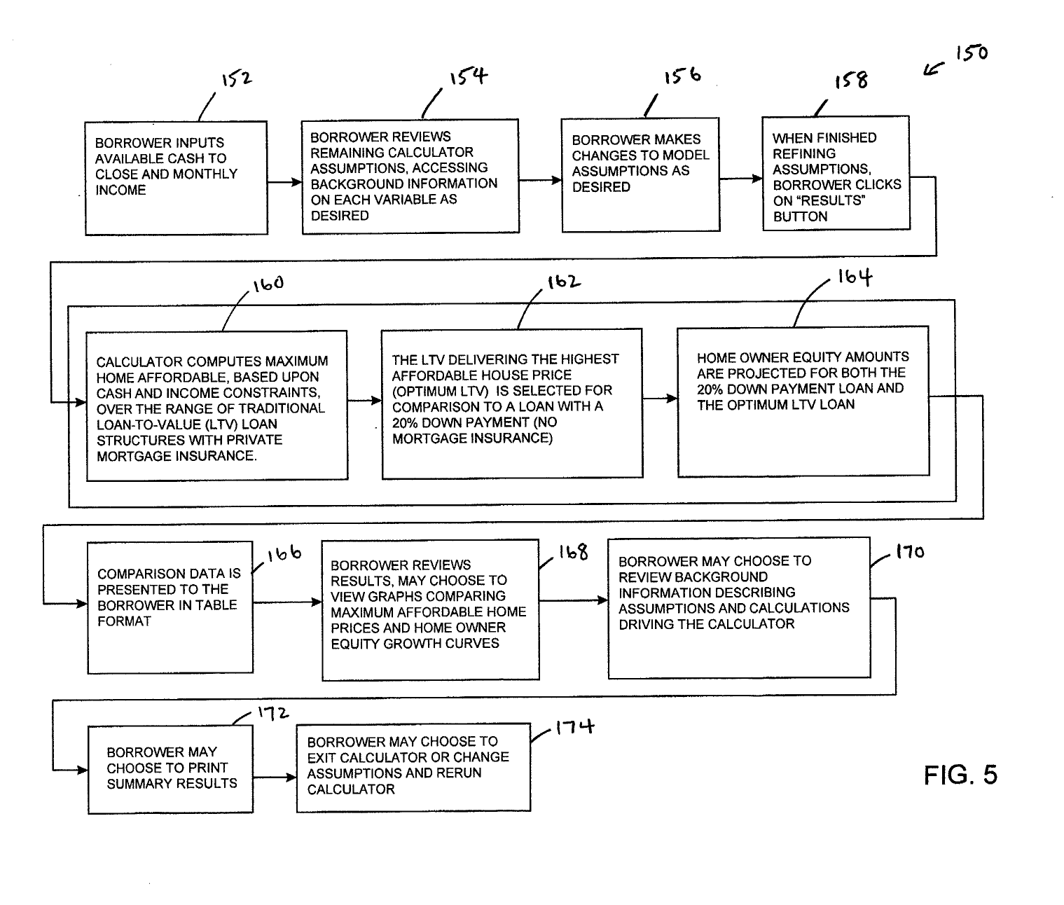

FIG. 5 shows a flowchart illustrating a method 150 according to the present invention. In step 152, the borrower inputs the amount of cash available to close and the borrower's monthly income. In step 154, the borrower reviews the remaining calculator assumptions, accessing background information on each variable, as desired. In step 156, the borrower makes changes to the model assumptions, as desired. In step 158, when the borrower is finished refining the assumptions, the borrower clicks on a button labeled “RESULTS.”

In step 160, the Homeowner Equity Calculator computes the maximum home affordable, based upon cash and income constraints, over the range of traditional LTV loan structures using mortgage insurance. In step 162, the computer selects the LTV that delivers the highest affordable house price for comparison with a loan based upon a 20% down payment, that is, without mortgage insurance. The LTV delivering the highest affordable house price is referred to as the “Optimum LTV.” In step 164, the Homeowner Equity Calculator projects future equity amounts for both the 20% down payment loan and the Optimum LTV loan.

In step 166, the comparison data generated by the Calculator is presented to the borrower in table format. In step 168, the borrower reviews the results of the comparison, and may elect to view graphs generated by the Calculator comparing maximum affordable home prices and home owner equity growth curves. In step 170, the borrower may choose to review background information describing assumptions and calculations driving the calculator. In step 172, the borrower may choose to print a summary of the results. In step 174, the borrower may choose to exit the Calculator or change assumptions and rerun the Calculator.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

I claim:

1. A system for optimizing a borrower's use of mortgage insurance based upon projections of future home equity, comprising:
a central processing unit having electronic access to mortgage insurance information stored in memory; and
a user interface for receiving user inputs indicative of a borrower's financial situation, closing costs, loan terms, and a house value appreciation assumption, and for providing those inputs to the central processing unit,
the central processing unit performing an analysis of the inputted information and calculating a maximum dollar amount of a house purchase price that the borrower can afford, based upon an optimal loan-to-value ratio, achievable using mortgage insurance, that maximizes future home equity,
the central processing unit further calculating a maximum dollar amount of a house purchase price that the borrower can afford without using mortgage insurance,
the central processing unit providing results of the calculations to the user interface for output to the user.

2. The system of claim 1, wherein the central processing unit provides the results of the calculations in table format.

3. The system of claim 1, wherein the central processing unit provides a graphical representation of the results of the calculations.

4. The system of claim 1, further including:
an Internet connection for connecting the computer to a remote website for downloading software components and mortgage insurance information.

5. The system according to claim 1, wherein the central processing unit calculates the maximum dollar amount of a house that can be purchased by the borrower, constrained by cash available to the borrower to close.

6. The system according to claim 1, wherein the central processing unit calculates the maximum dollar amount of a house that can be purchased by the borrower, constrained by the borrower's income.

7. The system according to claim 1, wherein the central processing unit calculates the projected home equity after predetermined periods of time.

8. The system of claim 7, wherein the central processing unit calculates the cumulative projected future home equity for years one through ten.

9. A method for optimizing a borrower's use of mortgage insurance based upon projections of future home equity, comprising:
(a) entering inputs into a central processing unit having electronic access to mortgage insurance information stored in memory, the inputs including the borrower's financial situation, closing costs, loan terms, and a house value appreciation assumption;
(b) performing an analysis of the inputted information, using the central processing unit, and calculating a maximum dollar amount of a house purchase price that the borrower can afford, based upon an optimal loan-to-value ratio, achievable using mortgage insurance, that maximizes future home equity,
(c) calculating a maximum dollar amount of a house purchase price that the borrower can afford without using mortgage insurance; and
(d) outputting from the central processing unit the results of the calculations.

10. The method of claim 9, wherein step (d) includes:
providing the results of the calculations in table format.

11. The method of claim 9, wherein step (d) includes:
providing a graphical representation of the results of the calculations.

12. The method of claim 9, further including:
downloading software components and mortgage insurance information from a remote website.

13. The method of claim 9, wherein steps (b) and (c) include:
calculating the maximum dollar amount of a house that can be purchased by the borrower, constrained by cash available to the borrower to close.

14. The method of claim 9, wherein steps (b) and (c) include:
calculating the maximum dollar amount of a house that can be purchased by the borrower, constrained by the borrower's income.

15. The method of claim 9, wherein steps (b) and (c) include:
calculating the projected home equity after predetermined periods of time.

16. The method of claim 15, further including:
calculating the projected future home equity years one through ten.

17. The method of claim 9, wherein step (a) includes:
reviewing calculator assumptions and accessing background information on each variable.

18. The method of claim 17, wherein step (a) further includes:
making changes to model assumptions.

19. The method of claim 9, further including the following step (e), after step (d):
(e) reviewing background information and assumptions driving the calculator.

20. The method of claim 19, further including the following step (f), after step (e):
(f) changing the assumptions and rerunning steps (b), (c), and (d).
